(19) United States
(12) Patent Application Publication
(10) Pub. No.: US 2008/0034915 A1
(43) Pub. Date: Feb. 14, 2008

(54) Conformable Covering Tape For Handles Of Sport Tools, Manufacturing Method And Covering Assemblly Incorporating Such Tape

(76) Inventor: Barbara Bigolin, Vicenza (IT)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/575,929

(22) PCT Filed: Sep. 26, 2005
(86) PCT No.: PCT/IB05/02830

§ 371 Date: Mar. 23, 2007

(30) Foreign Application Priority Data
Sep. 24, 2004 (IT) VI2004A000225

(51) Int. Cl. B62K 21/26

(52) U.S. Cl. 74/551.9; 427/207.1

(57) ABSTRACT

A padding tape for use on handles of sport tools, particularly bicycle handlebars, comprising a main body (2) formed by at least one substrate (3) of polymeric material having a top surface (4) and a bottom surface (5). The bottom surface (5) is designed to contact a handle (B). The polymeric material is a viscoelastic material having a high adhesive properties. The top surface (4) of this substrate is at least partly coated with a layer of paint (6) having high anti-adhesive properties, so that the padding tape only sticks with the bottom surface 5. A grip assembly for use on handles of sport tools, particularly bicycle handlebars, comprising at least one padding tape as described above, and at least one fibrous wrapping tape (8), designed to cover such tape. A process for making the above tape.

### FIELD OF THE INVENTION

The present invention generally finds application in the art of sports and leisure tools, and particularly relates to a conformable tape for use on handles of sport tools, particularly but without limitation for bicycle handlebar padding.

The invention further relates to a process for making the tape and a grip assembly incorporating such tape.

### State of the art

It is known that sports and leisure equipment and accessories, particularly bars and cylindrical, small-section objects are generally made of relatively rigid materials, such as metal, which provide a poor hand grip.

Grip is further reduced when the bar or the user's hands are wet, as is often the case during exercise.

Furthermore, the handles of sport tools and bicycle handlebars, which are exposed to jolts and vibrations are uncomfortable to use, because the elasticity of the material transfers all shocks and vibrations to the user's hands.

A number of technical arrangements have been developed to address the problem of shock absorption and comfortable grip.

U.S. Pat. No. 4,953,861 discloses and claims a tape structure comprising an outer layer having a plurality of substantially spherical gel-filled projections, which tape is then wrapped around the handle of a tennis racquet or another sports tool.

One drawback of this prior art arrangement is that this kind of tape considerably increases the section of the handle and the grip thereof by the user is uneasy and uncertain.

Also, this kind of tape, which has an outer layer containing a viscoelastic material cannot fit every handle shape. If the gel is cut, it comes out of its enclosure and is irremediably lost.

Other arrangements, substantially deriving from the same inventive principle, are disclosed in U.S. Pat. No. 5,088,734 and in US2004/050205.

From EP-A-0738525, a tape structure is known, which is composed of a substrate containing a recess which houses another layer of polyurethane material, such as gel or the like.

This arrangement also has drawbacks, because the provision of two superimposed layers limits the possibility of wrapping the tape. Furthermore, heat and moisture may cause the tape to deteriorate and fail with time.

Another arrangement, providing the superimposition of one polymeric substrate and one gel layer is known from EP-A-1435256, which forms the basis for the preamble of claim 1.

### SUMMARY OF THE INVENTION

The main object of this invention is to overcome the above drawbacks, by providing a padding tape which achieves high operating efficiency and has a relatively simple construction.

A particular object is to provide a padding tape which perfectly and firmly adheres against the handles of sport tools, while assuring a firm user's hand grip.

Another particular object is to provide a padding tape which has a viscoelastic main body having a highly simple construction, which may be shaped and cut as desired.

A further object of the invention is to provide a tape which is able to absorb the shocks and vibrations of the support on which it lays.

One more object of this invention is to provide a grip assembly for sport tools which is ready and easy to use, while ensuring a firm grip.

A further important object of the invention is to provide a highly accurate and easily repeatable process for making the tape.

These objects, as well as other objects that will be more apparent hereafter, are fulfilled thanks to a padding tape for use on handles of sport tools which, according to claim 1, comprises a main body formed by at least one substrate of polymeric material having a top surface facing outward and a bottom layer facing inward and designed to contact a handle, characterized in that said polymeric material is a highly adhesive viscoelastic material, the top surface of said substrate being at least partly coated with a layer of paint having high anti-adhesive properties.

Thanks to this particular arrangement, the tape of the invention is provided as a monolithic and compact main body with a very simple construction, which is able to be shaped and cut, to fit handles of any shape and size.

In another aspect of the invention, a grip assembly for use on handles of sport tools is provided, according to the independent claim 12, characterized in that it comprises at least one padding tape as described above, and at least one fibrous wrapping tape, designed to cover said at least one tape.

In yet another aspect of the invention, a process for making the above padding tape is provided, according to claim 14, characterized in that it comprises the steps of providing a mold having one internal cavity of a predetermined shape, with an anti-adhesive inner surface; coating said mold cavity with a layer of anti-adhesive paint; casting a layer of said highly adhesive viscoelastic material in the monomer state in said mold cavity, to obtain a free bottom surface, and a top surface in direct contact with said layer of anti-adhesive paint; coating said bottom surface with a layer of a material having anti-adhesive properties with respect to said highly adhesive viscoelastic material; closing the mold and keeping it closed as long as required for at least partial curing of said monomer; opening said mold and removing said layer of anti-adhesive material from said bottom surface; removing a main body formed by at least one substrate of said at least partly cured viscoelastic material.

### BRIEF DESCRIPTION OF THE DRAWINGS

Further features and advantages of the invention will be more apparent from the detailed description of a preferred, non-exclusive embodiment of a tape according to the invention, which is described as a non-limiting example with the help of the annexed drawings, in which:

FIG. 1 is an axonometric view of the tape according to the invention;

FIG. 2 is a broken away view of the tape of the invention, as taken along a plane II-II;

FIG. 3 is an axonometric exploded view of the assembly according to the invention;

FIG. 4 shows a flowchart of the process for making the tape of the invention.

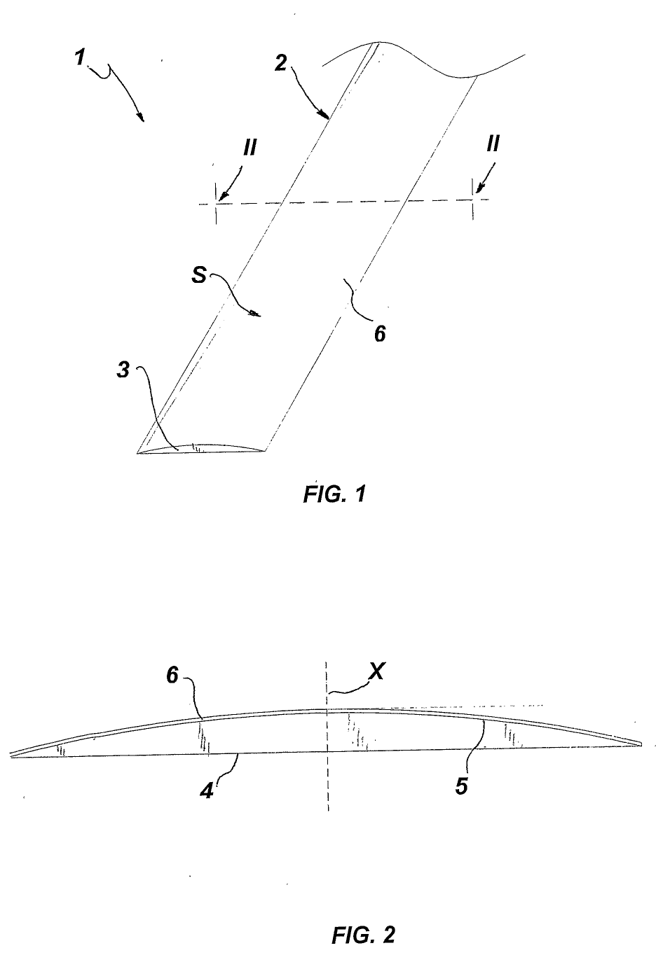

### DETAILED DESCRIPTION OF A PREFERRED EMBODIMENT

Referring to the above figures, the tape of the invention, generally denoted by numeral 1, comprises a main body 2, formed by at least one substrate 3, which has a top surface 4 and a bottom surface 5. The bottom surface 5 is designed to contact a handle B, whereas the top surface 4 faces outward to be directly or indirectly gripped by the user's hand.

The substrate 3 is made of a polymeric material, by virtue of the typical deformability properties of such type of material.

According to the invention, this polymeric material is a strongly adhesive viscoelastic material, i.e. having high adhesive properties. The use of a viscoelastic material allows to utilize the typical softness and controlled elasticity properties of these materials.

Thus, a real padding for the handle B is obtained, which is capable of absorbing and cushioning the vibrations of the tool on which it lays, while keeping its original shape unaltered with time.

Furthermore, the top surface 4 of the substrate 3 is at least partly coated with a layer of paint 6 having high anti-adhesive properties.

Thus, in the tape 1 only the bottom surface 5 has adhesive properties, to assist direct attachment thereof to the outer surface of the handle B, unlike the top surface, which improves user's grip.

This provides a tape with a very simple and compact construction, which may be easily attached to a handle B by the bottom surface 5 thereof, while allowing a user to have an easy grip on the top surface 4.

The coating of the latter with the layer of paint 6 will assure a firm, easy and “clean” grip, even though the material of the substrate 3 has high adhesive properties.

In fact, the tape 1 combines the advantages of a padding that strongly sticks with the surface on which it lays, and those of a firm and secure grip, which are critical features for a product designed for sports activities.

The highly adhesive viscoelastic material shall preferably have a Shore A hardness of 0 SHA to 40 SHA, more preferably of about 25 SHA. This will allow the tape 1 to have a specific shape, and will provide a product that may be cut and molded as desired, to fit any kind of handle B.

Advantageously, the highly adhesive viscoelastic material may be a gel, preferably selected from the group of polyurethane gels, such as the one manufactured and sold with the trademark TECHNOGEL® by the manufacturer with the same name. These types of gel have a high viscosity, while maintaining some elastic memory.

Conveniently, the polyurethane gel may have a Shore OO hardness of 10 SHOO to 70 SHOO, more preferably of about 45 SHOO.

The use of high viscosity polyurethane gel provides a soft and light-weight product, which is highly effective as a padding for handles of sport tools. Furthermore, this type of material does not degrade with time and is reusable, the original adhesiveness being restorable by a simple washing step using normal household cleaners.

Also, this gel may be preferably hygroscopic, to absorb the moisture and sweat which unavoidably forms on the hands of a user as a result of exercise effort, in any weather condition.

The paint may be conveniently selected from the group of polyurethane paints adapted to impart high anti-adhesive properties.

Furthermore, the paint will be permeable, so that it will oppose no resistance to moisture transfer from the user's hand to the basic layer 3.

According to a preferred embodiment, the layer of paint 6 may have substantially the same area S as the whole top surface 4 of the substrate 3. This will assure a proper “clean” grip all over the surface of the tape 1.

Advantageously, the substrate 3 may have a substantially convex shape, with the maximum thickness s at the center line X of the substrate 3. By this arrangement, the tape 1 will provide an even easier grip, by having an ergonomic shape that follows the natural profile of the hand.

Conveniently, the maximum thickness s may be of 0 mm to 5 mm, and is preferably of about 3 mm. Thus, although a sufficient amount of material is provided to absorb shocks, the section of the handle B is not excessively increased, and an easy grip is achieved.

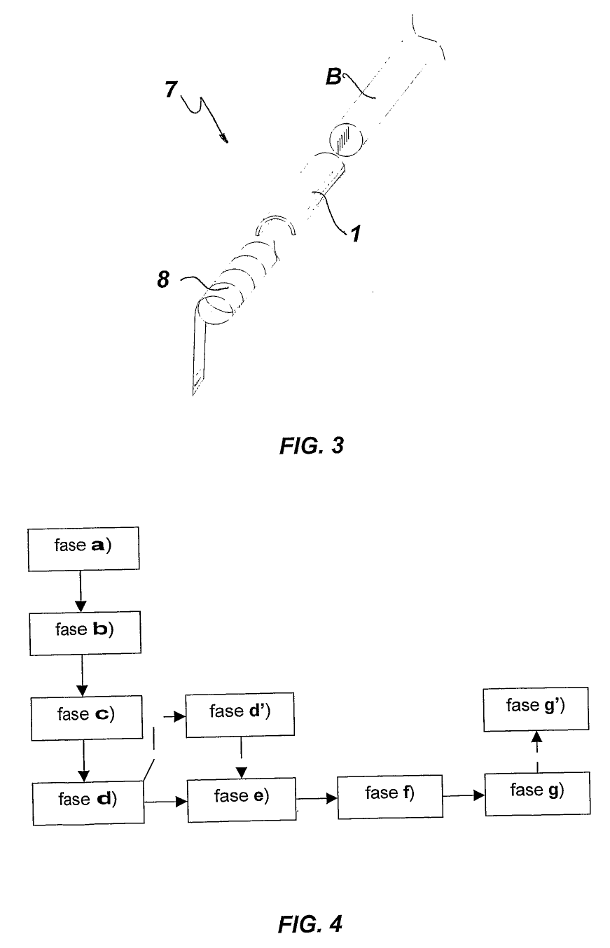

Particularly referring to FIG. 3, a grip assembly is shown for use on handles B of sport tools, generally denoted by numeral 7.

According to the invention, it comprises at least one padding tape 1 as described above, and at least one wrapping tape 8, for instance made of a fibrous material, preferably microfiber, which is designed to cover said at least one tape.

Thanks to the above assembly 7, the process of padding sport tools handles is very quick and simple. The tape 1 has to be simply wrapped around the handle B, possibly after a suitable cutting step, so that it firmly adheres thereto by its bottom surface 5, i.e. the adhesive surface, and then wrapped with the tape 8.

This provides the combined advantages deriving from the soft feel and the shock-absorbing quality of the handle B, and from a very firm grip, due to the provision of the tape 8.

A process for making the above tape comprises the following steps. In the first step a) a mold is first provided, having an internal cavity of a predetermined shape, the inner surface whereof has anti-adhesive properties.

Then, in step b) the mold cavity is coated with a layer 6 of a anti-adhesive paint.

This step is followed by step c), in which a layer of a highly adhesive viscoelastic material in the monomer state is cast in the cavity, to obtain a free bottom surface 5 and a top surface 4 in direct contact with the anti-adhesive paint layer 6.

A step d) follows, in which the bottom surface 5 is coated with a layer of material having anti-adhesive properties with respect to the highly adhesive viscoelastic material.

In step e) the mold is closed and kept closed as long as required for at least partial curing of the monomer.

This step is followed by a step f) in which the mold is opened and the layer of material having anti-adhesive properties is removed from the bottom surface 5.

Finally in step g), a main body 2 is removed from the mold, which is formed by at least one substrate of the at least partly cured viscoelastic material.

Said inner surface may be conveniently coated with a layer of anti-adhesive material.

Advantageously, step d) may be followed by a step d′) in which the bottom surface 5 is subjected to rolling, to remove any air bubbles formed during the previous steps.

Conveniently, a final step g′) may be provided for removing the fins, i.e. the excess material formed during the previous steps.

Thus, the above padding tape may be manufactured in a very simple manner. Thanks to the rapidity of its steps, the process is easily reproducible, while assuring a good processing accuracy.

The above disclosure clearly shows that the tape of the invention fulfills the proposed objects, and particularly the object of perfectly and firmly adhering against the handles of sport tools, while assuring a firm user's hand grip.

The use of a material with high adhesive properties, in combination with the paint with high anti-adhesive properties provides a tape having a highly adhesive bottom surface 5 and a top surface 4 that allows a firm, secure and clean grip.

The tape of the invention is susceptible of a number of changes and variants, within the inventive concept disclosed in the appended claims. All the details thereof may be replaced by other technically equivalent parts, and the materials may vary depending on different needs, without departure from the scope of the invention.

While the tape has been described with particular reference to the accompanying figures, the numerals referred to in the disclosure and claims are only used for the sake of a better intelligibility of the invention and shall not be intended to limit the claimed scope in any manner.

1. A padding tape for handles of sport tools, particularly bicycle handlebars, comprising a main body formed by at least one substrate comprising an adhesive viscoelastic polymeric material having a top surface facing outward to be directly or indirectly gripped by a user's hand and a bottom surface facing inward and attachable to the outer surface of a handle subject to vibrations, wherein the substrate having has a predetermined thickness and shape to absorb and cushion the vibrations on the handle and to provide a grip for the user, the top surface of said substrate being at least partly coated with a not releasable layer of anti-adhesive paint so that only said bottom surface of said substrate maintains its adhesiveness and directly sticks to the handle on which is attached.

2. Tape as claimed in claim 1, wherein the adhesive viscoelastic polymeric material has a Shore A hardness of 0 SHA to 40 SHA.

3. Tape as claimed in claim 1, wherein the adhesive viscoelastic polymeric material is a gel.

4. Tape as claimed in claim 3, wherein the gel comprises a polyurethane gel.

5. Tape as claimed in claim 4, wherein the polyurethane gel has a Shore OO hardness of 10 SHOO to 70 SHOO.

6. Tape as claimed in claim 1, wherein the paint comprises a polyurethane paints.

7. Tape as claimed in claim 3, wherein the gel is hygroscopic.

8. Tape as claimed in claim 1, wherein the paint is moisture permeable.

9. Tape as claimed in claim 1, wherein the layer of paint has substantially the same area as the top surface of said substrate.

10. Tape as claimed in claim 1, wherein the substrate has a substantially convex shape having a maximum thickness at a center line of said substrate.

11. Tape as claimed in claim 10, wherein the maximum thickness is up to 5 mm.

12. Grip assembly for use on handles of sport tools, particularly bicycle handlebars, said grip comprising at least one padding tape as claimed in claim 1 and at least one fibrous wrapping tape at least partially covering said at least one padding tape.

13. An assembly as claimed in claim 12, wherein the fibrous tape comprises microfiber.

14. A process for making a padding tape for use on handles of sport tools, particularly bicycle handlebars, as claimed in claim 1 wherein the process comprises the following steps:
a) providing a mold having one internal cavity of a predetermined shape, and having an anti-adhesive inner surface;
b) coating said mold cavity with a layer of anti-adhesive paint;
c) pouring a layer of adhesive viscoelastic material in the monomer state in said mold cavity, to obtain a free bottom surface and a top surface, said top surface being in direct contact with said layer of anti-adhesive paint;
d) coating said bottom surface of said adhesive viscoelastic material with a layer of a material having anti-adhesive properties with respect to said highly adhesive viscoelastic material;
e) closing said mold for a time sufficient for at least partial curing of said monomer to form a main body of at least one substrate of said at least partly cured viscoelastic material;
f) opening said mold and removing said layer of anti-adhesive material from said bottom surface of said at least partly cured viscoelastic material; and
g) removing the formed main body from the mold.

15. A process as claimed in claim 14, wherein the inner surface is coated with a layer of anti-adhesive material.

16. A process as claimed in claim 12, further comprising step d′) which comprises rolling said bottom surface to remove any air bubbles formed during the previous steps.

17. A process as claimed in claim 14, further comprising step g′) which comprises removing fins of excess material formed during the previous steps.

18. Tape as claimed in claim 1, wherein the adhesive viscoelastic polymeric material has a Shore A hardness of about 25 SHA.

19. Tape as claimed in claim 4, wherein the polyurethane gel has a Shore OO hardness of about 45 SHOO.

20. Tape as claimed in claim 10, wherein the maximum thickness is about 3 mm.
